(19) United States
(12) Patent Application Publication
(10) Pub. No.: US 2012/0132716 A1
(43) Pub. Date: May 31, 2012

(54) Case with extendable ribbon having graphics depicted thereon

(76) Inventor: Nigel Kelly, Rye Brook, NY (US)

(21) Appl. No.: 13/304,578

(22) Filed: Nov. 25, 2011

Related U.S. Application Data
(60) Provisional application No. 61/418,163, filed on Nov. 30, 2010.

(51) Int. Cl. G06K 19/00

(52) U.S. Cl. 235/487

(57) ABSTRACT

A case is provided which encloses a retractable ribbon, on which graphics or text may be added. A window may be provided in the case which reveals graphics or text that relate to the graphics or text extending from the case. A device may be included in the case which makes pre-recorded sounds related to the graphics or words.

This invention claims the priority filing date of provisional U.S. patent application No. 61/418,163.

### BACKGROUND OF INVENTION

Increasing advances in electronic media are making the written word available in devices capable of holding multiple books in downloadable file formats. As these technological advances are made the tactile experience of interacting with the written word is gradually being lost, lessening the quality of the reading experience.

The subject of this invention is concerned with reinstating an alternative tactile means for readers to experience reading and story-telling. This invention provides for a case, containing a flexible, or semi-flexible, ribbon, upon which is printed words that tell a story. The ribbon is retained within the case in a way that allows it to be pulled out to reveal words or pictures. A transparent window, or opening, in the case permits a section of the ribbon to be exposed, showing pictures that relate to the words that are shown as they exit the case.

As the ribbon is pulled from the case it may be held in place at any point by a ratchet, which secures its position. A button may be provided that releases the ratchet, to enable the ribbon to rewind back into the case for storage.

### BRIEF DESCRIPTION OF THE DRAWINGS

FIG. 1 View of casebook with ribbon extended

FIG. 2 View of casebook with ribbon stowed

### DETAILED DESCRIPTION OF THE PREFERRED EMBODIMENT

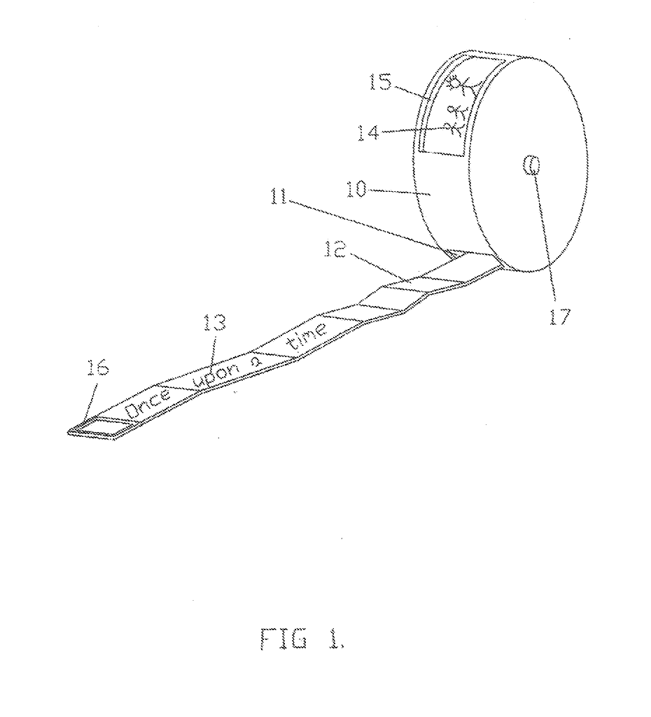

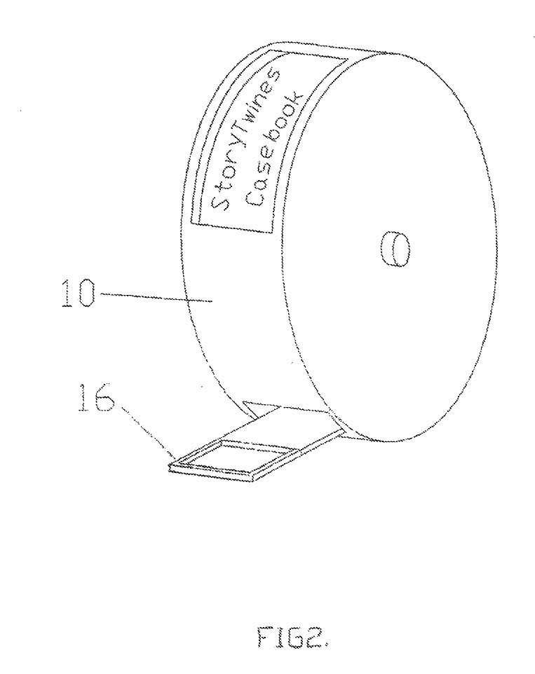

With reference to FIGS. 1 and 2, in a preferted embodiment there is provided a case 10 with a slot 11 from which a ribbon 12 is dispensed. On the ribbon 12 are depicted graphics, such as printed words 13 and/or printed pictures 14. The ribbon 12 is stowable in the case 10. With extension of the ribbon 12 from the case 10, the printed words 13 and/or the printed pictures 14 may present a story or other graphical arrangement, such as a thematic arrangement of graphics (e.g., holiday symbols and words; animal names and/or pictures; shapes, and so forth).

The printed words 13 may be located on one side of the ribbon 12 and on the reverse side of the ribbon may be located printed pictures 14. In addition, the case 10 may include a transparent window or opening 15 through which a portion of the ribbon 12 may be viewable. Preferably, the printed pictures 14 are located on the ribbon 12 to appear in the transparent window or opening 15, and which coincide with, and relate to, the words 13 exposed on the ribbon 12. In this manner, the ribbon 12 may be extended from the case 10 with the printed pictures 14 being viewable through the transparent window or opening 15 as the related printed words 13 are viewable on an exposed portion of the ribbon 12. The ribbon 12 is pulled from the case by means of a tab 16, and may be held by a ratchet mechanism within the case 10 until the ratchet is released by button 17.

As a second embodiment, the invention may include pre-recorded sounds that become audible in conjunction with certain sections of the ribbon 12 reaching pre-determined points of extension from the case 10. For example, sounds of a cow may be heard at the point where the word ‘cow’ appears from the case 10 at slot 11 and/or a picture of a cow appears in window 15.

As a third embodiment, the invention may allow the user to record their own sounds at certain sections of the ribbon 12 reaching pre-determined points of extension from the case 10, such that those sounds may be played-back at the point where given words appears from the case 10 at slot 11 and/or given pictures appear in window 15.

What is claimed is:

1. A case enclosing an extendable ribbon on which is depicted words, wherein extension of the ribbon out of the case reveals said words.

2. A case enclosing an extendable ribbon on which is depicted graphics, wherein extension of the ribbon out of the case reveals said graphics.

3. An assembly as in claim 2 wherein said case includes a transparent window or opening that reveals said graphics.

4. An assembly comprising an extendable ribbon on which graphics or words are depicted, with an embedded device for making pre-recorded noises that are made as the ribbon reaches different points of extension from the case.

5. An assembly comprising an extendable ribbon, with an embedded device for making sounds that are recorded by the user to relate to graphics revealed as the ribbon reaches different points of extension from the case.
